(19) United States
(12) Patent Application Publication
(10) Pub. No.: US 2019/0026366 A1
(43) Pub. Date: Jan. 24, 2019

(54) METHOD AND DEVICE FOR PLAYING VIDEO BY EACH SEGMENT OF MUSIC

(71) Applicant: MFU Co., Inc, Seoul (KR)

(72) Inventors: Young Soo PARK, Seoul (KR); Ki Song JUNG, Seoul (KR)

(73) Assignee: MFU Co., Inc, Seoul (KR)

(21) Appl. No.: 16/068,420

(22) PCT Filed: Jan. 6, 2017
(86) PCT No.: PCT/KR2017/000225

§ 371 Date: Jul. 6, 2018

(30) Foreign Application Priority Data
Jan. 7, 2016 (KR) 10-2016-0002263

(51) Int. Cl. G06F 17/30; G10H 1/36; H04N 21/8547; H04N 21/234; G10H 1/00

(52) U.S. Cl. CPC G06F 17/30787; G10H 1/368; G10H 2220/106; H04N 21/23424; G10H 1/0008; H04N 21/8547

(57) ABSTRACT

A method of playing a video by a content server according to the present disclosure includes: selecting a music to be played according to a user input; reading information on channels and segments of the selected music to be played; Mapping video segments corresponding to at least one of each channel and each segment to the music to be playing on the basis of the information about channels of the music to be played and segments, and playing the video segments mapped to the music to be played so that the video can be played by each segment of the music.

### TECHNICAL FIELD

The present disclosure relates to a method and device for playing video according to respective segments of music.

### BACKGROUND

With the development of IT technology, online music streaming and distribution industry is being activated. Recently, there has been a trend that many composers collaborate and compose music by dividing music into several segments or parts. Because those parts as well as the whole music can be considered as a copyrighted music, there is a need for a technique of creating and playing music in part. In addition, if parts of music are managed, a technique of recording and playing music as a video is required so that players or singers of respective parts can be visualized and identified.

### SUMMARY

The present disclosure is for solving the above-mentioned technical problems. For this purpose, the present disclosure provides a method and device for playing and recording a video according to respective segments of music.

According to one embodiment of the present disclosure, a method for a content server to play a video includes: selecting a music to be played according to a user input; reading information on channels and segments of the selected music to be played; mapping the video segments corresponding to at least one of each channel and each segment to the music to be played based on the information about the channels and segments of the music to be played; and playing the video segments mapped to the music to be played.

Preferably, each of the segments includes eight bars.

Preferably, the mapping step includes mapping the entire segment of the video having a highest user preference among the videos of the channel of the music to be played held by the content server for each channel.

Preferably, the mapping step includes mapping one video segment having a highest user preference among video segments of the corresponding segment of the music to be played held by the content server for each segment.

Preferably, the mapping step includes selecting one channel for the music to be played according to the user input; and mapping the video segment having a highest user preference for each segment among the videos of the channel of the music to be played held by the content server.

Preferably, the mapping step includes mapping the video segment having a highest user's preference among the video segments of the corresponding segment of the corresponding channel of the music to be played held by the content server for each channel and each segment.

Preferably, the mapping step includes mapping the video segments according to the user input.

Preferably, the method further includes storing a list of the video segments mapped to the music to be played; and providing the stored list to another user.

Preferably, the method further includes displaying a thumbnail of the video segments mapped to the music to be played.

Preferably, the playing step includes: activating or deactivating the playing of the video segments mapped to the music to be played according to at least one of each channel and segmentation according to the user input; and playing only those of the video segments mapped to the music to be played whose playback is activated.

Preferably, the playing steps includes: selecting at least one of a channel and a segment for recording the video according to the user input; and playing only the remaining ones of the video mapped to the music to be played, excluding at least one of the selected channels and the segments.

Preferably, the method further includes recording the user's video input during the play time of the selected segment.

Preferably, the entire video is played when receiving an input of listening to all music from the user for one of the video segments mapped to the music to be played.

Preferably, a purchase screen of the video is displayed when receiving a sound source purchase input from the user for one of the video segments mapped to the music to be played.

Preferably, when a user inputs a like/dislike input for one of the video segments mapped to the music to be played, the recommendation number of the corresponding video segment is increased/decreased accordingly.

Preferably, when a user inputs a like/dislike input for all video segments mapped to the music to be played from a user, the recommendation number of each of the video segments mapped to the music to be played is increased/decreased.

According to one embodiment of the present disclosure, a content server includes: a database for storing information on channels and segments of a plurality of music; a music selection unit for selecting a music to be played according to the user input; an information reading unit for reading information on channels and segments of the selected music to be played from the database; a video mapping unit for mapping the video segments corresponding to the channel and the segment for each channel and each segment to the music to be played based on the information about the channel and the segment of the music to be played; and a video playing unit for playing the video segments mapped to the music to be played according to the segmentation sequence.

The present disclosure includes a computer program stored on a medium for causing a computer to operate the above methods.

The present disclosure includes a computer-readable recording medium on which a program for performing the above methods is recorded.

In the above methods, the segments of the music to be played include at least the first segment and the second segment, the mapped video segments are played on a video display, and the mapping step includes: mapping a video segment(s) of the first set corresponding to at least one of a plurality of channels related to the first segment together at a position corresponding to the first segment of the music to be played; and mapping a second set of video segments(s) corresponding to at least one of the plurality of channels related to the second segment together at a position corresponding to the second segment of the music to be played. Also, the playing step includes: dividing the video playing display into a plurality of parts to simultaneously play the first set of video segments(s) mapped together, and distributing and playing the first set of video segments(s) on the divided display; and dividing the video playing screen into a plurality of parts to simultaneously play the second set of video segments(s) mapped together, and distributing and playing the second set of the video segments (s) on the divided screen.

Preferably, the advertisement is played in at least a part of the divided video playing screen.

Preferably, the channel exists in N (where N is an integer of 2 or more), and the mapped video segments are played on a video playing screen, wherein the mapping comprises mapping together one or more video segments corresponding to one or more channels played in each segment, and the reproducing step includes dividing the video playing screen into M parts (where M is an integer equal to or greater than N), and distributing the one or more video segments mapped together to the video playing screen divided into M parts.

Preferably, the advertisement is played in an unused portion of the divided video playing screen.

Preferably, N is a number one of 2 to 16

Preferably, the music to be played includes one or more channels, and in the playing step, the volume of the one or more channels is individually adjustable according to the user input.

In the above content servers further including the video recording unit for storing the video, the content server communicates with a user terminal generating and transmitting the first video segment, and the content server stores the first video segment generated and transmitted by the user terminal in the video recording unit and stores information about the relationship between the first video segment and the second video segment stored in the video recording unit in a database.

Preferably, the information about the relationship is stored as an XML document.

Preferably, the content servers further include: a music network generating unit for generating a music network including a line connecting a plurality of nodes and nodes; and a music network playing section for playing at least a part of the generated music network, wherein the music network comprises the first node and the second node, wherein the first node represents a first video edited by a first user, the second node represents a second video edited by a second user, and the first video includes at least a part of the first video segment produced by the first user, and the second video includes at least a part of the second video segment produced by the second user, and wherein a solid line connecting the first node and the second node is generated when the first video includes the second video segment included in the second video, and information for relation between the first video segment and the second video segment regarding the first video is stored in the database.

Preferably, when the user selects the first node, the content server performs at least one of the operations of: playing the first video corresponding to the first node; receiving a like/dislike input from the user and increasing/decreasing a recommendation number of the first video or a first video segment corresponding to the first node; the user downloading the first video or the first video segment corresponding to the first node; and the user sharing the first video corresponding to the first node.

Preferably, information about a shape of the first node is changed when the at least one operation is performed.

Preferably, a node of a video produced without using a video segment produced by another person has a different attribute from a node of the video edited by using a video segment created by another person.

### BRIEF DESCRIPTION OF THE DRAWINGS

FIG. 1 is a drawing schematically showing a configuration of a content server according to one embodiment of the present disclosure.

FIG. 2 illustrates an example in which a music is segmented into eight bars.

FIG. 3 is a flowchart schematically showing a flow of a video playing method according to one embodiment of the present disclosure.

FIG. 4 shows an example in which each channel information and thumbnail image of video segments are displayed on a screen according to one embodiment of the present disclosure.

FIG. 5 shows an example of playing videos for respective channels in divided screens according to one embodiment of the present disclosure.

FIG. 6 shows an example of playing videos for respective channels in divided screens according to one embodiment of the present disclosure.

FIG. 7 is a view schematically showing a configuration of a database according to one embodiment of the present disclosure.

FIG. 8 is a drawing schematically showing a flow of a process of displaying an initial screen according to one embodiment of the present disclosure.

FIG. 9 is a view schematically showing a flow of a video playing process according to one embodiment of the present disclosure.

FIG. 10 depicts an example of a music network according to one embodiment of the present disclosure.

FIG. 11 shows a flow chart of a step of generating a music network, in accordance with one embodiment of the present disclosure.

FIG. 12 shows a flow chart in which possible operations are performed when selecting a node in a music network, in accordance with one embodiment of the present disclosure.

### DETAILED DESCRIPTION

Hereinafter, preferred embodiments of the present disclosure will be described in detail with reference to the attached drawings in order to clarify the technical idea of the present disclosure. In the following description of the present disclosure, a detailed description of known functions and configurations incorporated herein will be omitted when it may make the subject matter of the present disclosure rather unclear. Same reference numbers and symbols are given for components which has substantially identical functional components among drawings even marked with different drawing numbers. For convenience of description, apparatus and method are described together when necessary.

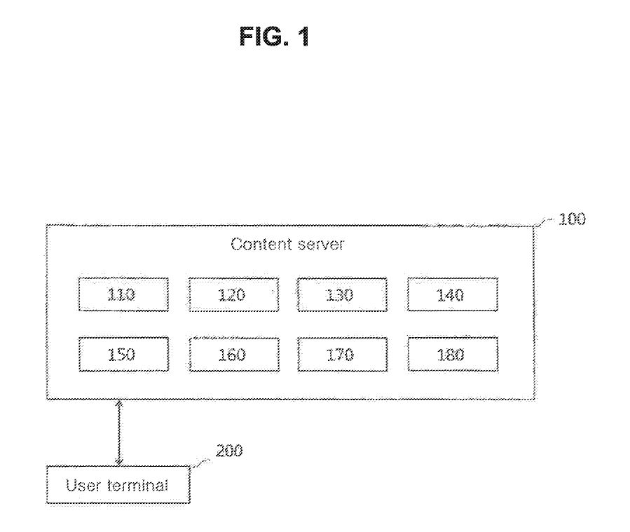

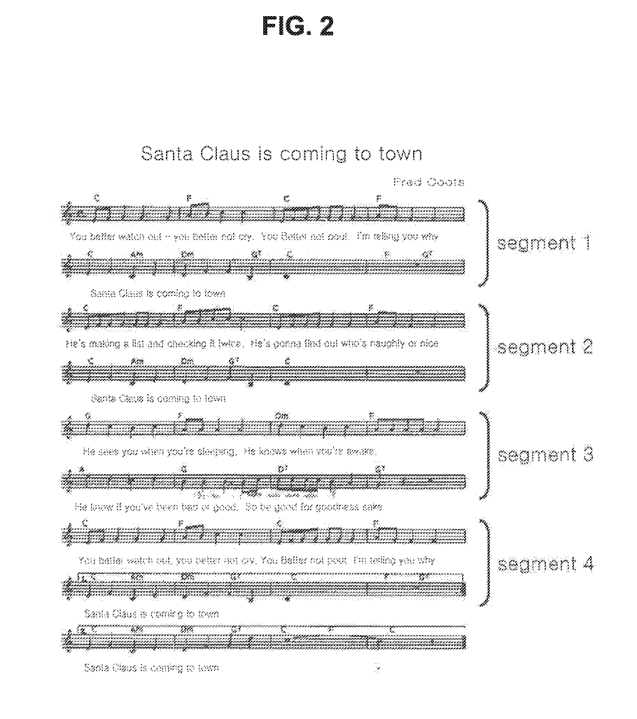

FIG. 1 is a drawing schematically showing a configuration of a content server according to one embodiment of the present disclosure. Referring to FIG. 1, a content server 100 according to one embodiment of the present disclosure includes a music selection unit 110, an information reading unit 120, a video mapping unit 130, a video playing unit 140, database 150, a video recording unit 160, a music network generating unit (170), The content server 100 is capable of communicating with a user terminal 200 via a network. The user terminal 200 may includes, but not limited, any electronic device available for communicating with the content server 100 such as general PCs (personal computers) which are general desktop or laptop computers, a mobile terminal such as a smart phone, a tablet PC, a PDA (personal digital assistant), and a mobile communication terminal. The user terminal 200 may receive and reproduce video or a music network (which will be described later) provided from a content server or through a network. Also, the user terminal 200 may generate and edit a video and transmit the video to the content server 100. The content server 100 according to the present disclosure is a multi-channeled music video playing server, which stores and manages a channel-by-channel video and metadata for various music in the database 150. The metadata of the music include information about the channels and segments of each music. In the present disclosure, a channel refers to a track of each musical instrument or voice composing a complete song, for example, a voice, a piano, a keyboard, a guitar, a bass, a drum, a string, a chorus, etc. According to one embodiment, a channel may include a track of two or more musical instruments or voices. Thus, for example, a piano and a drum can be played simultaneously in one channel-by-channel video. In the present disclosure, segmentation refers to dividing music by a certain length. In general, music can be divided into intro, verse, bridge, refrain, and ad-lib. Each segment consists of 8 to 16 bars, so that entire running time of the music is about 3 or 4 minutes. Preferably, in the present disclosure, eight bars are considered as one segment. FIG. 2 shows an example in which music is segmented into eight bars. In the present disclosure, a channel-by-channel video of a music is a video in which a musician plays a corresponding music with a specific musical instrument (in case of a voice channel, the video is showing a singer singing a song, and for convenience of explanation, the voice is referred to as being ‘played’ as an instrument). Also, such music videos can be segmented according to the segments of music. The segmented video is called as a video segment. The video may be a video playing a complete piece of music, or just a few segments of the music.

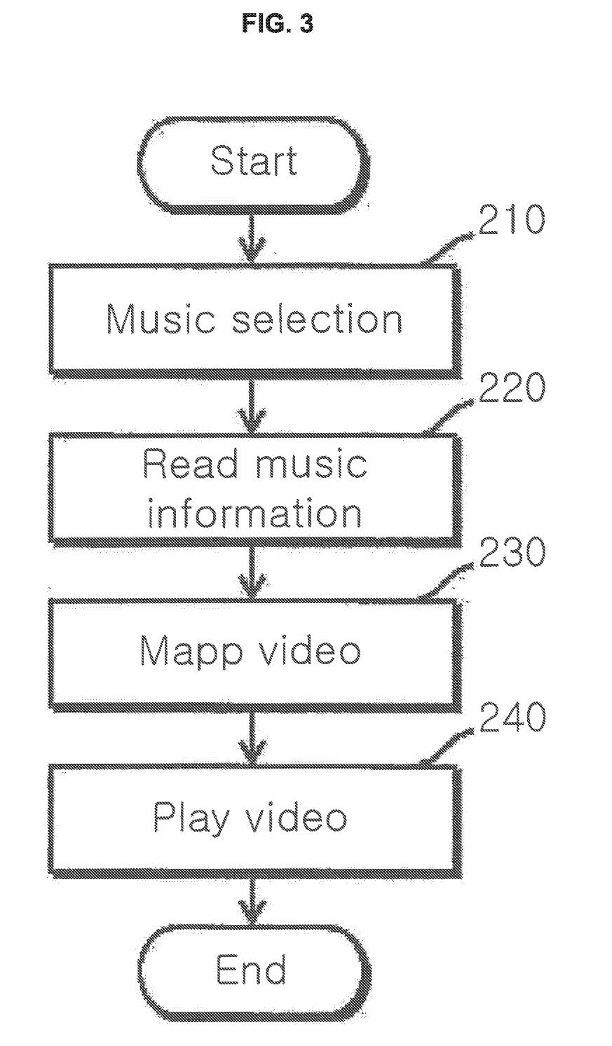

FIG. 3 is a flowchart schematically showing a flow of a video playing method according to one embodiment of the present disclosure. Referring to FIG. 3, in operation 210, the music selection unit 110 of the content server 100 selects a music to be played according to a user input. In operation 220, the information reading unit 120 reads information of the channels and segments of the selected music to be played from the database 150. In operation 230, based on the information of the channel and the segment of the readout part of the music to be played, the video mapping unit 130 maps the video segments corresponding to at least one of each channel and each segment to the music to be played in accordance with the corresponding channels and segments. In operation 240, the video playing unit 140 plays the video segments mapped to the music to be played according to the segmentation order. That is, the content server 100 according to one embodiment of the present disclosure may map and play various music videos that are different for each of the channels and segments for the music selected by the user.

In another embodiment, video may be played in accordance with the order selected by the user, rather than in accordance with the segment order. For example, the user may remove the intro or change the order of the verse, in which case the video can be played in the order selected by the user. There may be various embodiments of the method of mapping the video to the music.

In a first embodiment, the video mapping unit 130 may map the whole segments of the video having the highest user's preference among the videos of the corresponding channel of the music to be played which is held by the content server for each channel. For example, regarding a piano channel, it is possible to map a video having the highest preference among the videos of piano playing the music to be played. Also, regarding a voice channel, it is possible to map a video having the highest preference among the videos of the music to be played. Here, the preference is an index reflecting the preference of the users of the content server 100 regarding each video or segments of each video. For example, the preference may be generated based on information that users click “like” or “dislike” while watching a video. In the first embodiment, the video having the highest preference of the user is mapped for each musical instrument regarding the music to be played.

The content server 100 may display thumbnails of mapped video segments on a screen after the video mapping. The video playing unit 140 may simultaneously play all videos mapped on a channel-by-channel basis or play videos of a specific channel according to the user's choice when playing video. This may be applied in the other embodiments to be described below.

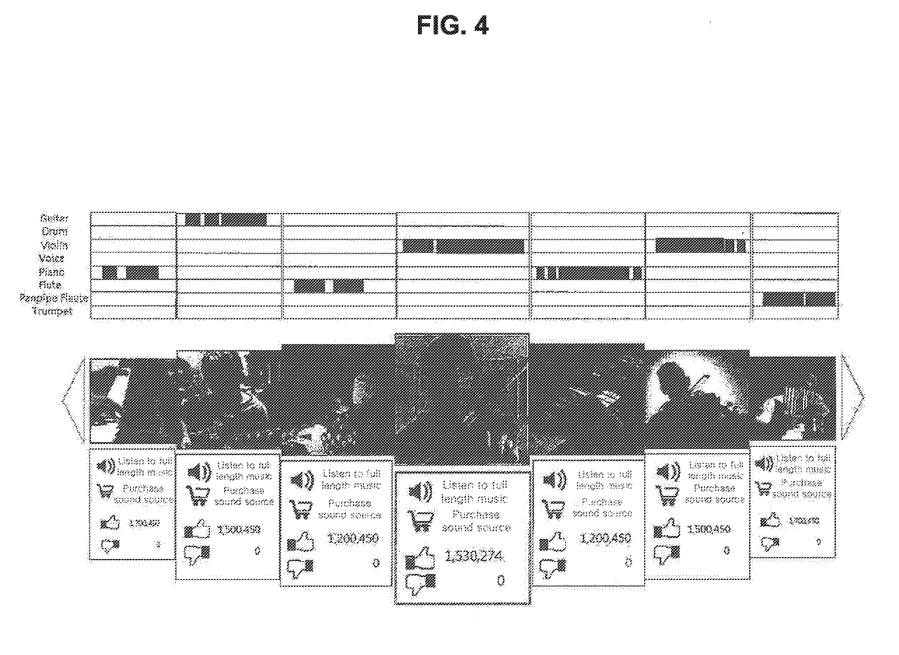

In a second embodiment, the video mapping unit 130 may map each segment of the music to be played, which is selected by the user, into a video segment having the highest user preference among the videos of the corresponding segments of the music to be played, which is held by the content server. That is, the segment 1 is mapped into the video segment with the highest preference among all video segments of all musical instruments that play the segment 1 and the segment 2 is mapped into the video segment with the highest preference among the video segments of all musical instruments that play the segment 2. In this case, since the video for the musical performance with the highest preference is mapped for each segment, only one channel is playing at a time during the video playing of the video playing section 140. Also, a different musical instrument may be played for each segment. In the present embodiment, an example of displayed information of each channel and a thumbnail of a video segment on the screen is shown in FIG. 4.

In a third embodiment, the video mapping unit 130 may select one of the channels for the music to be played according to the user input, and may map a video having the highest preference among the videos in the channel for the music to be played, which is stored by the content server in a segment-by-segment basis. For example, when the user selects the piano channel, the segments having the highest preference are mapped by each segment among the piano performance videos of the music to be played.

According to the embodiment, when different musical instruments are being played per segment according to the second embodiment, if the user selects “single channel playback” for one of the video segments (for example, video segments being currently played), it is possible to map and play the highest-preferred video segments for the corresponding channel as in the third embodiment. At this time, the remaining channels is not playing the video.

In the fourth embodiment, the video mapping unit 130 may map each segment of the music to be played, which is selected by the user, per segment and per channel into the video segment having the highest user preference among the videos of the corresponding segment of the music to be played for the corresponding channel, which is held by the content server. In this case, all the channels are played simultaneously, while the videos having the highest preference are played in a channel-by-channel basis for each segment. The number of thumbnails being displayed may be a product of the number of channels and the number of segments. Also, multiple videos may be played simultaneously or only the video selected by the user may be played.

In the fifth embodiment, the video mapping unit 130 may map video segments according to a user input, according to at least one criterion among a channel-by-channel basis or a segment-by-segment basis for the music to be played, which is selected by the user. In addition, video segments having high preference may be automatically mapped by the first to fourth embodiments, and then some video segments may be mapped with some changes according to the user input. The content server 100 may store a list of mapped video segments according to the user input, and then provide the stored list to other users. Accordingly, the user of the content server 100 may distribute the video playing information created by himself/herself to the other users.

In a sixth embodiment, the video mapping unit 130 may map video segments in a plurality of channels together into one segment of the music to be played. Thereafter, the video playing unit 140 divides the video playing screen into a plurality of parts to play the video segments in a plurality of channels mapped together in one segment simultaneously, and plays the plurality of video segments per channel in the divided parts on the video playing screen. In one embodiment, the video mapping unit 130 may map a plurality of the video segments of one channel together into one segment of the music to be played. For example, the piano channel video produced by the user A, the piano channel video produced by the user B and the piano channel video produced by the user C may be mapped together into the first segment. Thereafter, the video playing unit 140 divides the video playing screen into a plurality of parts to play the video segments in a plurality of channels mapped together in one segment simultaneously, and plays the plurality of video segments per channel in the divided parts on the video playing screen. In one embodiment, in at least one of the divided screens, an image that is independent from the channel video, such as an advertisement, may be played.

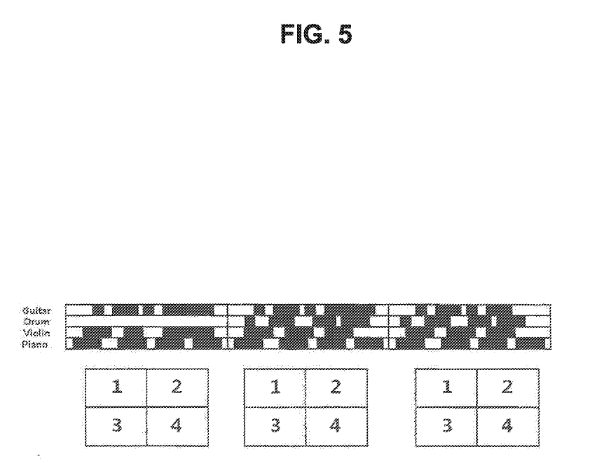

In one embodiment, the video playing screen may be divided into a fixed number of parts according to the segments of the music to be played. The screen may be divided into the same number of parts as the number of the existing channels or may be divided into more or less number of parts than the number of the existing channels. The screen may be divided into four or nine parts, but not limited thereto. Referring to FIG. 5 illustrating one embodiment related thereto, for example, there are four channels in total, and the screen is divided into four parts. In the first segment of the music to be played back, there are three video segments per channel among the four channels, which are displayed on the screens marked as 1, 2, and 3 of the divided screens, respectively, and the advertisement is played on the screen marked as 4. In the second segment, there are video segments per channel for all four channels, which are played on all the divided screens. In the third segment, there are video segments per channel for all four channels. However, the video segment per channel is played on the screen marked as 1, 3 and 4, while the advertisement is played on the screen marked as 2. In an example, no image may be played on at least one of the divided screens.

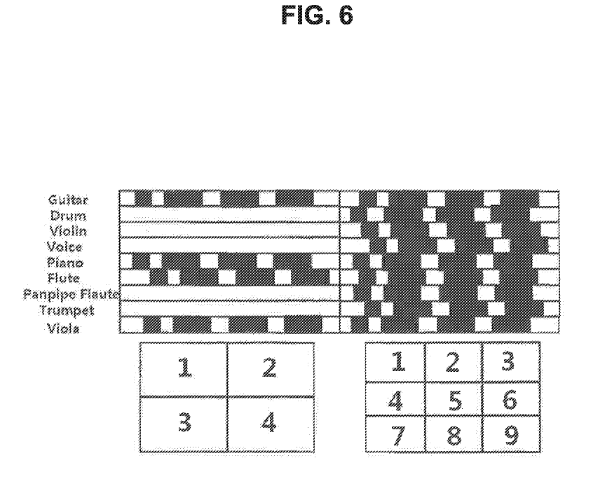

In another embodiment, the video playing screen may be divided into different numbers of parts for each segment of the music to be played. Referring to FIG. 6 illustrating one embodiment of the present disclosure, for example, if there are four video segments per channel in the first segment of the music to be played and there are nine video segments per channel in the second segment, the screen is divided into four parts to play the four video segments per channel on each divided screen in the first segment. Also, in the second segment, the screen is divided into nine parts, and nine video segments per channel can be played on each divided screen. In another example related thereto, if there are nine video segments in the first segment of the music to be played and three video segments in the second segment, the screen is divided into nine parts in the first segment and the nine segments of the video are played on each divided screens. In the second segment, the screen is divided into four parts and three video segments are played on the three screens while the advertisement can be played on the other screen. In one embodiment, the screen may be divided in some segments, and the screen may not be divided in some segments.

The video playing unit 140 may activate or deactivate the function of playing per channel and/or per segment for the video segments mapped to the music to be played according to the user input, and the video segments for which playing is activated only can be played. Thus, the user can play only a specific part of music without playing a specific musical instrument. In the present disclosure, an operation of the video playing unit 140 playing the video or music may include an operation of video playing unit 140 sending the user terminal 200 the video or music so that the user terminal 200 displays or outputs the video or music. In one embodiment, the volume of each channel is individually adjustable. For example, in the music composed of videos of flute and piano channel, the volume of the flute channel may be controlled to be loud while the volume of the piano channel may be controlled to be low.

The content server 100 may include a video recording unit 160 and may add a video by receiving and recording a video from a user. When listening to the played music, the user may prevent a certain musical instrument from being played so that the video is recorded with playing the corresponding musical instrument (for example, guitar) or prevent a certain segment from being played so that the video is recorded for the specific segment (for example, refrain part). For example, the video playing unit 140 may select a channel to record the video according to the user input and then play only the other channels than the selected channel among the video segments mapped to the music to be played. Also, the video playing unit 140 may select a channel and segment to record the video according to the user's input and may play the other channels than the selected segment of the selected channel among the video segments mapped to the music to be played. At this time, the video recording unit 160 may record the video input of the user during the time when the selected segment is played. Some parts or entire part of the video recording unit 160 may be arranged outside of the content server 100.

Hereinafter, the manner in which the content server 100 records the user's video will be described in more detail. The content server 100 may communicate with the user terminal 200 of the user who produces a video and may receive at least one of the video segments and information on the channels and segments of the plurality of music. When the content server 100 receives a video, which is not stored in the video recording unit 160, from the user terminal 200, the received video may be stored in the video recording unit 160. For example, in case where the user generates only some partial video segments of one whole video and utilizes the video segments stored in the video recording unit 160 for the remaining part, the user terminal 200 may transmit only newly generated video segments and the content server 100 may store only the newly generated video segments. At this time, the content server 100 may store the relation between the videos, for example, the mapping relation between the music segment and the video segment, a playing sequence of the video segments and the like using the storage location information of the newly generated video segment and the storage location information of the pre-stored video that the user has used, in the database. In storing and transmitting the related information on the video, a technique for storing the storage location information of the video segment and a relation therebetween, such as an Extensible Markup Language (XML), may be used. Then, when the user desires to receive and play the music including the regenerated video, the content server 100 may transmit the stored relationship information, for example, an XML document to the user terminal 200, and the user terminal 200 may receive the video mapped on a music per segment by using information in the XML document and may display or output the video. As such, the content server 100 can prevent duplicated storage of video and efficiently transmit information to the terminals.

In an embodiment, the user uses the video of flute and piano channels stored in the content server 100 in producing a video of music A per channel. Also, in case where the user produces a violin channel video of refrain of the music A, the user terminal 200 transmits only the violin channel video of the refrain part. After that, when the user terminal 200 wants to play music including flute, piano, and violin channel video, the content server 100 transmits XML, but not the entire video, and the user terminal may output piano and violin channel video per music segment according to the information of XML document.

In an embodiment, if the flute and piano channel videos are stored in an external server (not shown) other than the content server 100, the XML document may include location information in the corresponding external server of the flute and piano channel video.

As shown in FIG. 4, the content server 100 displays a button such as ‘Listen to full length music’, ‘Purchase Sound Source’, ‘Like’, ‘Dislike’ for each of the video segments mapped to the music to be played. If the user clicks the ‘Listen to full length music’ button on one of the video segments mapped to the music to be played, the content server 100 may play the entire video. When the user clicks the ‘Purchase Sound Source’ button, the content server 100 may display a purchase screen for all or a part (for example, segment) of the corresponding video. If the user clicks the ‘like’ or ‘dislike’ button, the content server 100 may increase or decrease the recommendation number of the corresponding video segment accordingly. The content server 100 may display a “like” or “dislike” button (not shown) for the entire currently mapped video segments, and when the user clicks on it, the recommendation number of all the currently mapped video segments may increase or decrease. Similarly, it is possible to perform process such as purchase of a sound source for the entire currently mapped video segments.

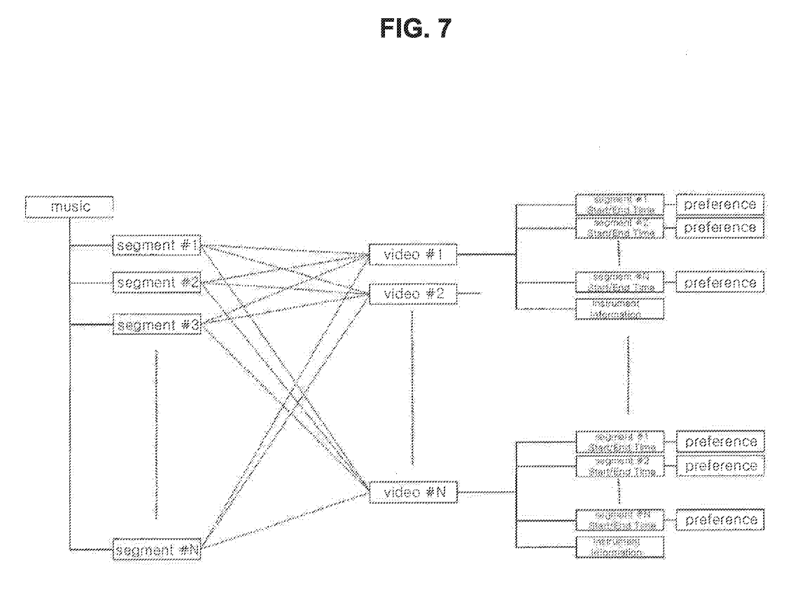

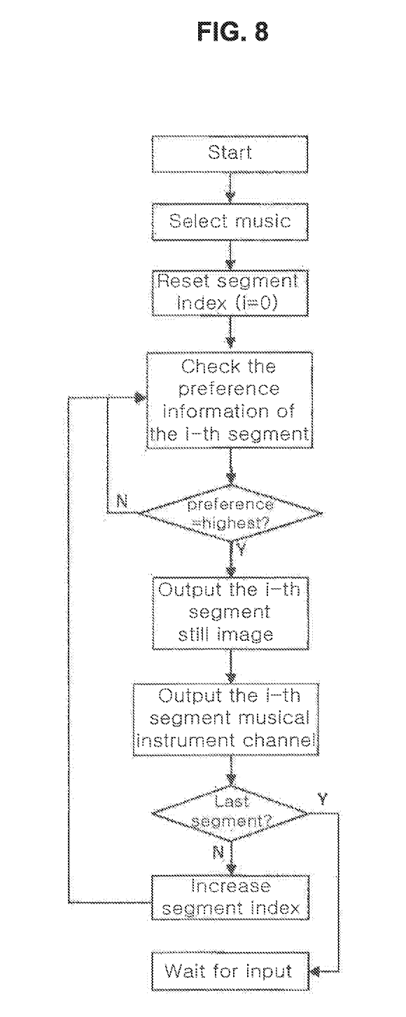

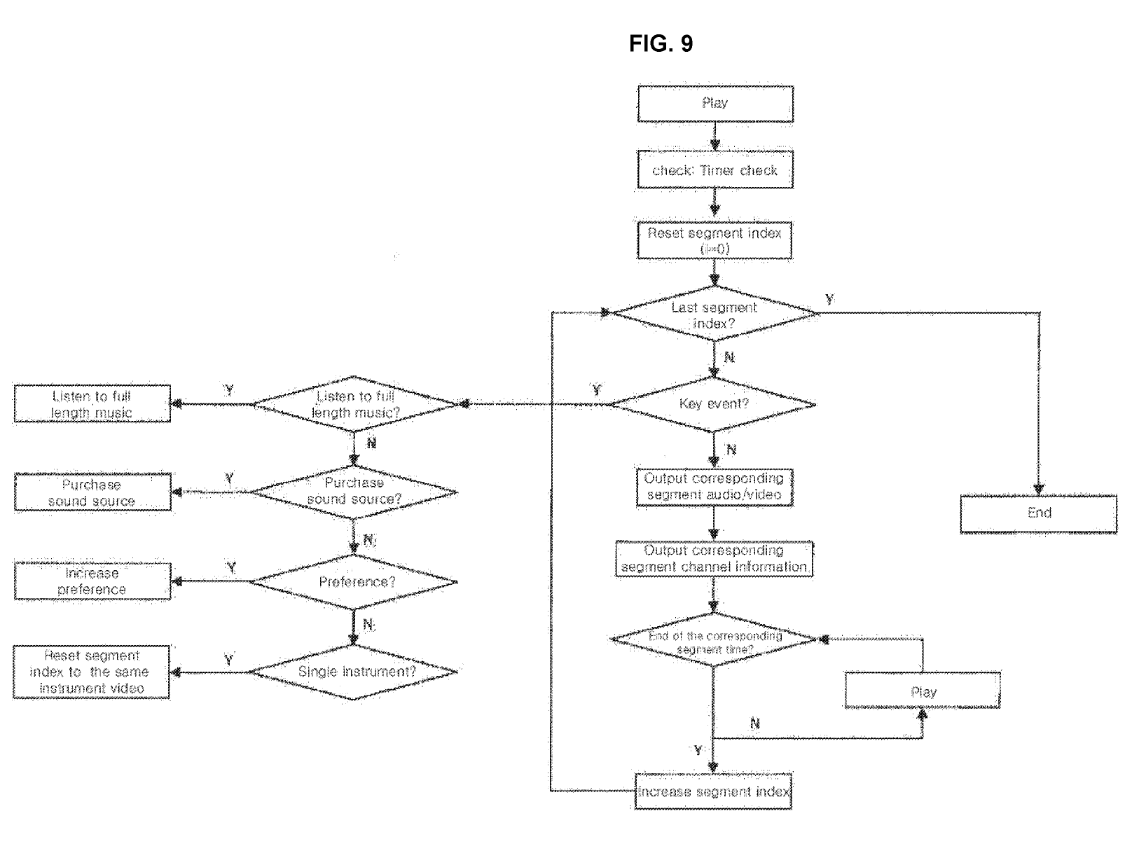

FIG. 7 is a diagram schematically showing the configuration of a database according to one embodiment of the present disclosure, and shows a mapping between each segment and a video, and segment information, musical instrument information and preference information stored in association with each video. FIG. 8 is a diagram schematically illustrating the flow of an initial screen display process according to one embodiment of the present disclosure, and shows that a video segment having the highest user preference is mapped to the music to be played per segment according to the second embodiment and that the mapping result is displayed as shown in FIG. 4. Referring to FIG. 8, while increasing a segment index indicating each segment of music to be played from 0 to 1, a video segment having a highest preference is mapped per segment, and a still image and musical instrument channel information of the mapped video are displayed on a screen. FIG. 9 is a view schematically showing a flow of a video playing process according to one embodiment of the present disclosure. Referring to FIG. 9, the video segments and channel information of each segment are sequentially output while increasing the segment index from 0 to 1 according to the play time by the timer, and the corresponding process is performed when a key event, for example, ‘Listen to full length music’, ‘Purchase sound source’, ‘input of preference (recommendation)’, and ‘playing of a single instrument (channel)’ occurs.

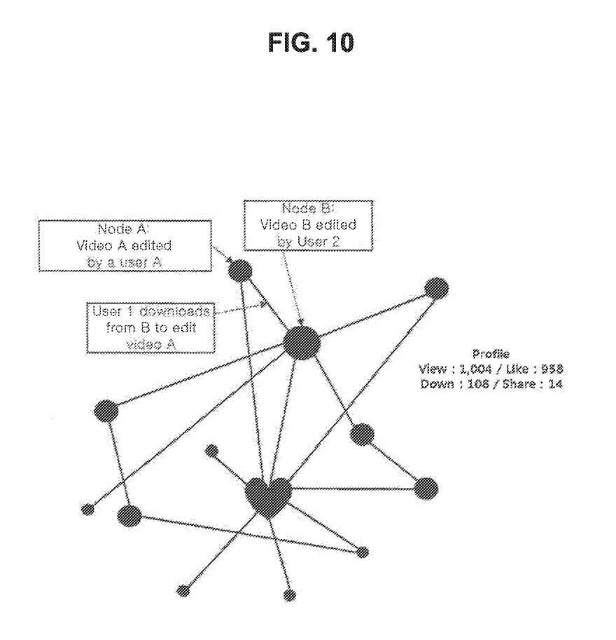

FIG. 10 illustrates one embodiment of a music network showing a sharing situation of a video generated by a user. The music network includes a plurality of nodes and solid lines connected to the nodes at both ends, in which a node indicates the user-edited video and a solid line indicates that the user has downloaded the video from another node to edit the video. Referring to FIG. 10, node A represents video A edited by the user 1, and node B represents video B edited by user 2. A solid line connecting A and B indicates, for example, that the video segment of the node B is used in the video A. The video A related to the node A includes at least a video segment A produced by the user 1 and a video segment B produced by the user 2. The video segments A and B are stored in the video recording unit 160 of the content server 100 while the information that the video A includes the video segments A and B is stored in the database 150 of the content server 100, for example, as an XML document. The music network generating unit 170 of the content server 100 generates a node and a solid line and the music network playing unit 180 transmits the information of at least a part of the generated music network to the user terminal (not shown) capable of communicating with the content server 100 for display.

In one embodiment, when a user selects a node, an operation of playing a video corresponding to the corresponding node as a whole or a part, an operation of increasing or decreasing the recommendation number of segments corresponding to the corresponding node with receiving a like/dislike input from a user, an operation of a user to download a video or a video segment corresponding to the node, and an operation of a user to share the video corresponding to the first node on his/her Social Networking Service (SNS) account, message, e-mail and the like can be performed. According to one embodiment, the shape of the corresponding node may be changed as the number of times of performing the playing operation, the operation of increasing/decreasing the recommendation number, the download operation and/or the sharing operation increases. For example, the node is circular, and the size of the circular node may be enlarged as the number of performing the above operations increases. According to one embodiment, when a video is produced without using a video of another person's or on another node, the corresponding node may have an attribute, for example, a shape or color, which is different from a general node. For example, these nodes may have a heart or crown shape. The shape change of such a node can be made by changing shape information related to the node, for example, one of a plurality of data fields indicating the attribute of the node. By providing such a visualization interface, the user can easily recognize which movie is actively used and which music is originally created. In one embodiment, when a node is selected, the information of the video producer of the node is output. In one embodiment, when a node is selected, the number of times of playing video, like/dislike clicks, download count, number of times of being shared, and the like, of the node are output.

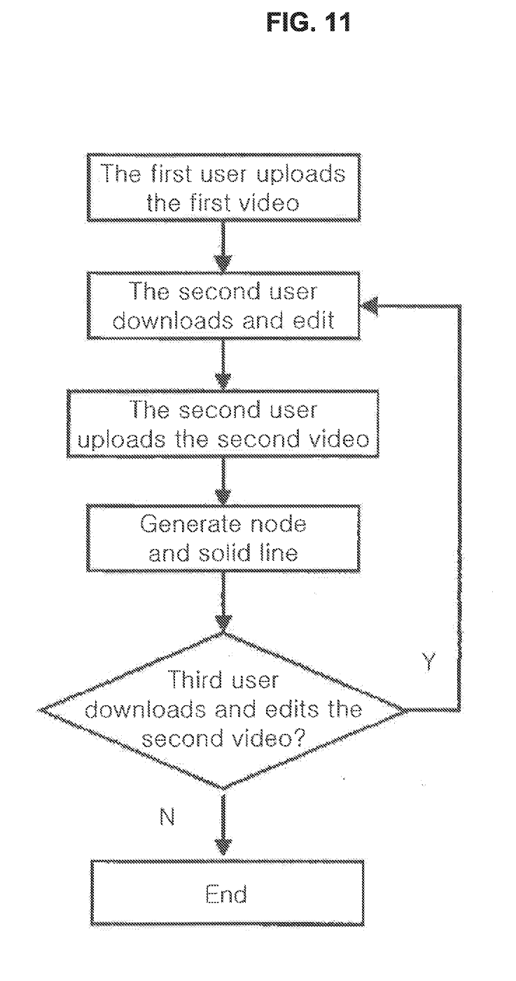

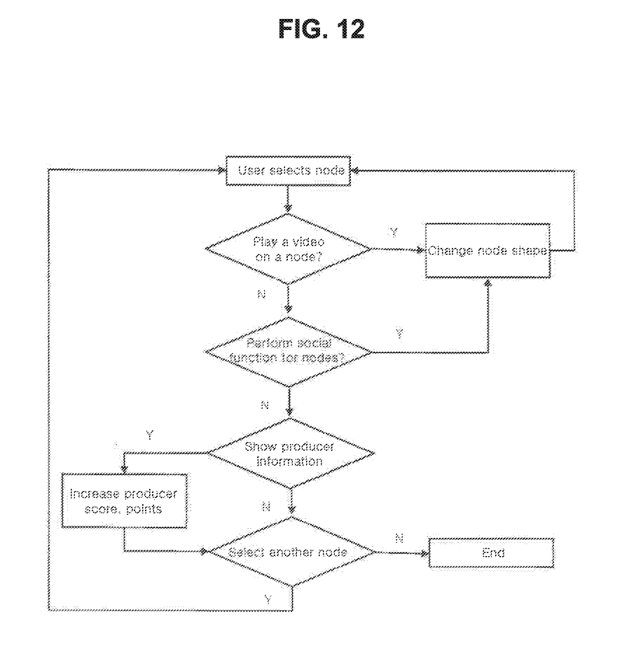

FIG. 11 is a flowchart of a step of generating a music network. When a first user uploads a first video to the content server 100, a second user downloads at least a portion of the first video and edits it together with the video segment produced by the second user. Also, the second user produces the second video and uploads it to the server 100. In this case, a node corresponding to each of the first video and the second video is generated, and a solid line connecting the two nodes is generated. FIG. 12 shows a flowchart in which a possible operation is executed when selecting a node in the music network. When the user selects a node, it decides whether to play a video corresponding to the node, a social function (an operation for increasing/decreasing a recommendation number, a sharing operation, etc.). Thereafter, it is possible to determine whether to display the producer information of the node.

The above example configurations according to the present disclosure may be implemented through various ways such as program commands operated by processors, software modules, microcode, computer programs recorded on recording media readable by a computer (including all devices having an information processing function), logic circuits, customized semiconductors or firmware. Examples of the computer-readable recording medium include a ROM, a RAM, a CD, a DVD, a magnetic tape, a hard disk, a floppy disk, a hard disk, and an optical data storage device. In addition, the computer-readable recording medium may be distributed over a network-connected computer system so that computer readable code can be stored and executed in a distributed method.

The present disclosure has been described in detail with reference to the preferred embodiments shown in the drawings. It is to be understood that these embodiments are illustrative rather than limiting, and should be considered in an illustrative rather than a restrictive sense. The true scope of technical protection of the present disclosure should be determined by the technical idea of the attached claims rather than the above descriptions. Although specific terms have been used herein, they are used for purposes of describing the concept of the disclosure only and are not used to limit the meaning or the scope of the disclosure as defined in the claims. It will be understood by those of ordinary skill in the art that various changes in form and details may be made therein without departing from the spirit and scope of the invention as defined by the attached claims. It is to be understood that the equivalents include all components that are invented in order to perform the same function irrespective of the currently known equivalents as well as the equivalents to be developed in the future.

1. A method for a content server to play a video, the method comprising:
selecting a music to be played according to a user input;
reading information on channels and segments of the selected music to be played;
mapping the video segments corresponding to at least one of each channel and each segment to the music to be played based on the information about the channels and segments of the music to be played; and
playing the video segments mapped to the music to be played.

2. The method according to claim 1, wherein each of the segments includes eight bars.

3. The method according to claim 1, wherein the mapping comprises:
mapping the entire segment of the video having a highest user preference among the videos of the channel of the music to be played held by the content server for each channel.

4. The method according to claim 1, wherein the mapping comprises:
mapping one video segment having a highest user preference among video segments of the corresponding segment of the music to be played held by the content server for each segment.

5. The method according to claim 1, wherein the mapping comprises:
selecting one channel for the music to be played according to the user input; and
mapping the video segment having a highest user preference for each segment among the videos of the channel of the music to be played held by the content server.

6. The method according to claim 1, wherein the mapping comprises:
mapping the video segment having a highest user's preference among the video segments of the corresponding segment of the corresponding channel of the music to be played held by the content server for each channel and each segment.

7. The method according to claim 1, wherein the mapping comprises:
mapping the video segments according to the user input.

8. The method according to claim 7, further comprising:
storing a list of the video segments mapped to the music to be played; and
providing the stored list to another user.

9. The method according to claim 1, further comprising:
displaying a thumbnail of the video segments mapped to the music to be played.

10. The method according to claim 1, wherein the playing comprises:
activating or deactivating the playing of the video segments mapped to the music to be played according to at least one of each channel and segmentation according to the user input; and
playing only those of the video segments mapped to the music to be played whose playback is activated.

11. The method according to claim 1, wherein the playing comprises:
selecting at least one of a channel and a segment for recording the video according to the user input; and
playing only the remaining ones of the video mapped to the music to be played, excluding at least one of the selected channels and the segments.

12. The method according to claim 11, further comprising:
recording the user's video input during the play time of the selected segment.

13. The method according to claim 1, wherein the entire video is played when receiving an input of listening to all music from the user for one of the video segments mapped to the music to be played.

14. The method according to claim 1, wherein a purchase screen of the video is displayed when receiving a sound source purchase input from the user for one of the video segments mapped to the music to be played

15. The method according to claim 1, wherein when a user inputs a like/dislike input for one of the video segments mapped to the music to be played, the recommendation number of the corresponding video segment is increased/decreased accordingly.

16. The method according to claim 1, wherein when a user inputs a like/dislike input for all video segments mapped to the music to be played from a user, the recommendation number of each of the video segments mapped to the music to be played is increased/decreased.

17. A computer program stored on a medium for causing a computer to operate the method of claim 1.

18. A computer-readable recording medium on which a program for performing the method of claim 1.

19. A content server for performing the method of claim 1, comprising:
a database for storing information on channels and segments of a plurality of music;
a music selection unit for selecting a music to be played according to the user input;
an information reading unit for reading information on channels and segments of the selected music to be played from the database;
a video mapping unit for mapping the video segments corresponding to the channel and the segment for each channel and each segment to the music to be played based on the information about the channel and the segment of the music to be played; and
a video playing unit for playing the video segments mapped to the music to be played according to the segmentation sequence.

20. The method according to claim 1, wherein the segments of the music to be played include at least the first segment and the second segment, the mapped video segments are played on a video display,
wherein the mapping comprises:
mapping a video segment(s) of the first set corresponding to at least one of a plurality of channels related to the first segment together at a position corresponding to the first segment of the music to be played; and
mapping a second set of video segments(s) corresponding to at least one of the plurality of channels related to the second segment together at a position corresponding to the second segment of the music to be played,
wherein the playing comprises:
dividing the video playing display into a plurality of parts to simultaneously play the first set of video segments(s) mapped together, and distributing and playing the first set of video segments(s) on the divided display; and
dividing the video playing screen into a plurality of parts to simultaneously play the second set of video segments(s) mapped together, and distributing and playing the second set of the video segments (s) on the divided screen.

21. The method according to claim 20, wherein the advertisement is played in at least a part of the divided video playing screen.

22. The method according to claim 1, wherein the channel exists in N (where N is an integer of 2 or more), and the mapped video segments are played on a video playing screen,
wherein the mapping comprises mapping together one or more video segments corresponding to one or more channels played in each segment, and
wherein the reproducing comprises dividing the video playing screen into M parts (where M is an integer equal to or greater than N), and distributing the one or more video segments mapped together to the video playing screen divided into M parts.

23. The method according to claim 22, wherein the advertisement is played in an unused portion of the divided video playing screen.

24. The method according to claim 22, wherein N is a number one of 2 to 16

25. The method according to claim 1, wherein the music to be played includes one or more channels, and
wherein in the playing, the volume of the one or more channels is individually adjustable according to the user input.

26. The content server according to claim 19, wherein the content server further comprises the video recording unit for storing the video,
wherein the content server communicates with a user terminal generating and transmitting the first video segment, and
wherein the content server stores the first video segment generated and transmitted by the user terminal in the video recording unit and stores information about the relationship between the first video segment and the second video segment stored in the video recording unit in a database.

27. The content server according to claim 26, wherein the information about the relationship is stored as an XML document.

28. The content server according to claim 19, further comprising:
a music network generating unit for generating a music network including a line connecting a plurality of nodes and nodes; and
a music network playing section for playing at least a part of the generated music network,
wherein the music network comprises the first node and the second node,
wherein the first node represents a first video edited by a first user, the second node represents a second video edited by a second user, and the first video includes at least a part of the first video segment produced by the first user, and the second video includes at least a part of the second video segment produced by the second user, and
wherein a solid line connecting the first node and the second node is generated when the first video includes the second video segment included in the second video, and information for relation between the first video segment and the second video segment regarding the first video is stored in the database.

29. The content server according to claim 28, wherein when the user selects the first node, the content server performs at least one of the operations of:
playing the first video corresponding to the first node;
receiving a like/dislike input from the user and increasing/decreasing a recommendation number of the first video or a first video segment corresponding to the first node;
the user downloading the first video or the first video segment corresponding to the first node; and
the user sharing the first video corresponding to the first node.

30. The content server of claim 29, wherein information about a shape of the first node is changed when the at least one operation is performed.

31. The content server according to claim 28, wherein a node of a video produced without using a video segment produced by another person has a different attribute from a node of the video edited by using a video segment created by another person.
